(19) United States
(12) Patent Application Publication
(10) Pub. No.: US 2011/0045211 A1
(43) Pub. Date: Feb. 24, 2011

(54) ARTIFICIAL TURF AND A METHOD OF MANUFACTURING THE SAME

(76) Inventors: Bi Zhang, Guangdong (CN); Yukun Chen, Guangdong (CN); Demin Jia, Guangdong (CN)

Correspondence Address: LACKENBACH SIEGEL, LLP, LACKENBACH SIEGEL BUILDING, 1 CHASE ROAD, SCARSDALE, NY, 10583, US

(21) Appl. No.: 12/740,142

(22) PCT Filed: Oct. 30, 2007
(86) PCT No.: PCT/CN2007/070994

§ 371 Date: Apr. 28, 2010

(51) Int. Cl. E01C 13/08; B05D 3/02; C08L 31/04

(52) U.S. Cl. 428/17; 427/385.5; 524/524

(57) ABSTRACT

An artificial turf is formed of grass fibers, a grass bottom and a rear glue. The grass fibers and the grass bottom are both made from polyethylene, polypropylene and/or polyamide, and the rear glue is mainly made from ethylene-vinyl acetate copolymer emulsion with filler and antioxidant, etc. The artificial turf is manufactured by making the rear-adhesive components into glue paste and coating it on the rear of the grass bottom fixed with grass fibers.

### TECHNICAL FIELD

The present invention relates to a novel artificial turf and a method of manufacturing the same, and more particularly to an artificial turf containing an ethylene-vinyl acetate copolymer and a method of manufacturing the same.

### BACKGROUND

Nowadays, the artificial turf has been extensively applied in gymnasiums, schools, hotels and building roofs etc. due to its superior properties such as anti-aging, sunscreen, waterproof, skid-free, wear resistance, comfortable foot feel, bright color, long life, low maintenance cost, weatherability and the like.

The artificial turf is mainly composed of a grass fiber, a grass bottom and a rear glue. Generally, the grass fiber and the grass bottom are made from thermoplastic polymer materials. For example, the grass fiber is mainly made from polyethylene, and the grass bottom is mainly made from polypropylene, while the rear glue is generally made from thermosetting polymer materials such as vulcanized carboxylic styrene-butadiene rubber or polyurethane. The role of the rear glue is to fix the grass fiber onto the grass bottom, and thereby it is hard to draw out the grass fiber from the grass bottom. The rear glue should be able to bond polyethylene and polypropylene together, and have performances such as strength, waterproof, heat resistance, cold resistance and anti-aging.

For example, the rear glue of the current artificial turf is generally made from carboxylic styrene-butadiene latex, calcium carbonate, sulfur and an accelerant. In particular, vulcanized carboxylic styrene-butadiene rubber is obtained by cross-linking of carboxylic styrene butadiene latex initiated by a vulcanizing system (sulfur and an accelerant) under a certain temperature (such as over 145° C.). The vulcanized carboxylic styrene-butadiene rubber is a thermosetting polymer material with crosslinked network-like molecular chains, which can not be melt or dissolved, can not be softened but only be decomposed by heat, and can not return to plastic state.

In current artificial turf, the grass fiber and the grass bottom are made from thermoplastic polymer materials, such as polyethylene or polypropylene, while the rear glue is made from thermosetting polymer materials such as vulcanized carboxylic styrene-butadiene rubber or crosslinked polyurethane. As well known in the art, a thermoplastic polymer can be molded repeatedly through softening by heat and solidifying by cooling within a particular temperature range. However, a thermosetting polymer material, after vulcanization and molding under a certain temperature, can not be remolded through increasing the temperature. Therefore, the compatibility between these two kinds of polymer is poor, and can not be recycled and re-used by methods such as melt blending. For the above reason, the current artificial turf made from polyethylene, polypropylene, carboxylic styrene-butadiene rubber or polyurethane etc. can not be recycled and re-used. On one hand, disposal or incineration of the artificial turf will pollute the environment and waste the resources, on the other hand, recycle of the grass fiber and the grass bottom after their separation from the rear glue will lead to over high cost of recycle.

### SUMMARY OF THE INVENTION

A novel artificial turf is proposed in the present invention to resolve such problems as non-compatibility, unable to be recycled as a whole etc. of the materials of the current artificial turf, wherein an ethylene-vinyl acetate copolymer is used as the main material of the rear glue in the present invention.

According to one aspect of the invention, an artificial turf comprised of a grass fiber, a grass bottom and a rear glue is provided, wherein the rear glue is mainly made from ethylene-vinyl acetate copolymer emulsion (VAE).

The term “ethylene-vinyl acetate copolymer emulsion” herein refers to the ethylene-vinyl acetate copolymer generally provided in a form of emulsion.

According to an embodiment of the invention, the content of the vinyl acetate of the ethylene-vinyl acetate copolymer in the ethylene-vinyl acetate copolymer emulsion (VAE) used for the rear glue is in the range of about 70˜90 mol %, preferably about 75˜90 mol %, more preferably about 80˜90 mol %, further preferably about 85˜90 mol %; and the solid content of the ethylene-vinyl acetate copolymer emulsion (VAE) is in the range of about 40˜60 wt. %, preferably about 45˜60 wt. %, more preferably about 50˜60 wt. %, further preferably about 55˜60 wt. %.

In an embodiment of the invention, the grass fiber is mainly made from one or more selected from polyethylene, polypropylene and polyimide; the grass bottom is mainly made from one or more selected from polyethylene and polypropylene.

According to the invention, the rear glue can further comprise one or more additives selected from filler and antioxidant.

The filler can be one or more selected from carbon black, silica, heavy calcium carbonate, light calcium carbonate, talc, montmorillonite, halloysite, magnesium hydroxide and aluminum hydroxide, preferably heavy calcium carbonate, magnesium hydroxide and aluminum hydroxide.

The antioxidant can be one or more selected from antioxidant 1010, antioxidant 245, antioxidant 246, antioxidant 264, antioxidant 3125, antioxidant DSTP, antioxidant DLTP, anti-oxidant CA, 2,6-di-tert-butyl-4-ethyl phenol, 2,6-di-tert-butyl-4-methoxy-methyl phenol, antioxidant P-EPQ, ditridecyl thiodipropionate and lauryl-stearyl thiodipropionate.

Ethylene-vinyl acetate copolymer (EVA), which is a thermo-melting polymer material, can be obtained by removing water from the ethylene-vinyl acetate copolymer emulsion through drying. EVA not only has properties of the crosslinked polymer used in the current rear glue but also is a thermoplastic polymer material, and therefore the polymer materials constituting the artificial turf of the present invention can all be thermoplastic materials which are compatible with each other, make it possible to recycle and process the artificial turf as a whole into a composite without individual recovery following by separation. Thus, the artificial turf of the present invention resolves the problem that the current artificial turf can not be recycled as a whole.

According to another aspect of the invention, a method of manufacturing the artificial turf comprising using the ethylene-vinyl acetate copolymer emulsion to form the rear glue of the artificial turf is also provided.

According to an embodiment of the invention, the method comprises the steps of: making components of the rear glue into a glue paste by uniformly pre-mixing, the components of the rear glue comprising the ethylene-vinyl acetate copolymer emulsion; and coating the uniformly pre-mixed glue paste onto the grass bottom fixed with the grass fiber.

According to an embodiment of the invention, the method comprises: after coating the glue paste, thermal-treating the artificial turf coated with the glue paste at a temperature of 110˜150° C.

Forming the rear glue of the artificial turf by using ethylene-vinyl acetate copolymer emulsion has the advantages of simplifying the manufacturing process, saving installation investment, increasing production efficiency, and enhancing the permeability of the rear glue through the grass bottom so as to enhance the bonding strength between the grass bottom and the grass fiber and prevent the grass fiber from departing from the grass bottom.

According to another aspect of the invention, a recycled material by recycling the artificial turf as a whole is provided, said material is obtained by heating and uniformly mixing the artificial turf of the invention as a whole at a temperature of 120˜180° C.

### BRIEF DESCRIPTION OF THE DRAWINGS

FIG. 1 shows the structure and composition of the artificial turf of the invention.

FIG. 2 shows a flow chart of a method of manufacturing the artificial turf according to an embodiment of the invention.

### BEST MODES FOR CARRYING OUT THE INVENTION

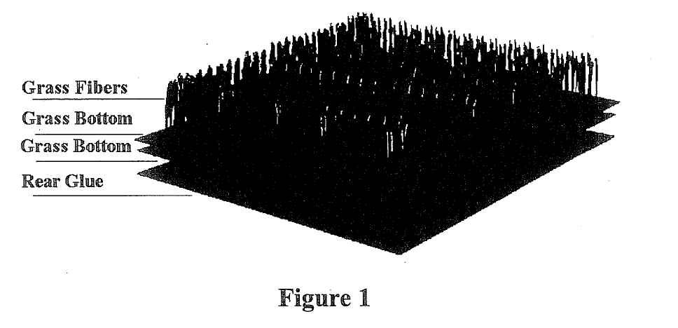

As shown in FIG. 1, the artificial turf of the invention is comprised of a grass fiber, a grass bottom and a rear glue. The formulation of the grass fiber and the grass bottom is the same as that of the current artificial turf, whereas the rear glue is prepared by using ethylene-vinyl acetate copolymer emulsion (VAE) as the primary material together with filler and antioxidant.

The content of the vinyl acetate of the ethylene-vinyl acetate copolymer in the ethylene-vinyl acetate copolymer emulsion (VAE) used in the invention is in the range of about 70˜90 mol %, preferably about 75˜90 mol %, more preferably about 80˜90 mol %, further preferably about 85˜90 mol %; the solid content of the ethylene-vinyl acetate copolymer emulsion is in the range of about 40˜60 wt. %, preferably about 45˜60 wt. %, more preferably about 50˜60 wt. %, further preferably about 55˜60 wt. %.

The ethylene-vinyl acetate copolymer emulsion (VAE) used in the invention can be such as DA102 and DA103 available commercially from DAIREN Corporation (DCC Corporation).

The grass fiber and the grass bottom of the artificial turf of the invention can be manufactured according to the prior art or obtained commercially. The manufacturing process thereof is omitted herein. Examples of the formulation for the rear glue of the artificial turf of the invention are given as follows.

### Example 1 of the Formulation for the Rear Glue

100 parts (by weight, the following parts are all by weight unless indicated explicitly) of VAE (an ethylene-vinyl acetate copolymer emulsion), 150 parts of a talc powder and 1 part of an antioxidant 1010.

### Example 2 of the Formulation for the Rear Glue

100 parts of VAE (an ethylene-vinyl acetate copolymer emulsion), 180 parts of a heavy calcium carbonate and 2 parts of an antioxidant 1010.

The manufacturing method of the artificial turf of the invention will be described in detail hereinafter. For convenience, the grass fiber and the grass bottom fixed together hereinafter will be referred as the turf for short.

The components for formulating the rear glue are pre-mixed uniformly into a glue paste ready for use. Then, the above glue paste is placed in a paste tank, and the turf is coated with the glue paste by passing through the top of the paste tank at a certain speed. The coated turf undergoes a thermal treatment by passing through the hot bellows at a certain speed in which hot air (with a temperature of 110˜150° C.) blows the turf from top to bottom in the hot bellows.

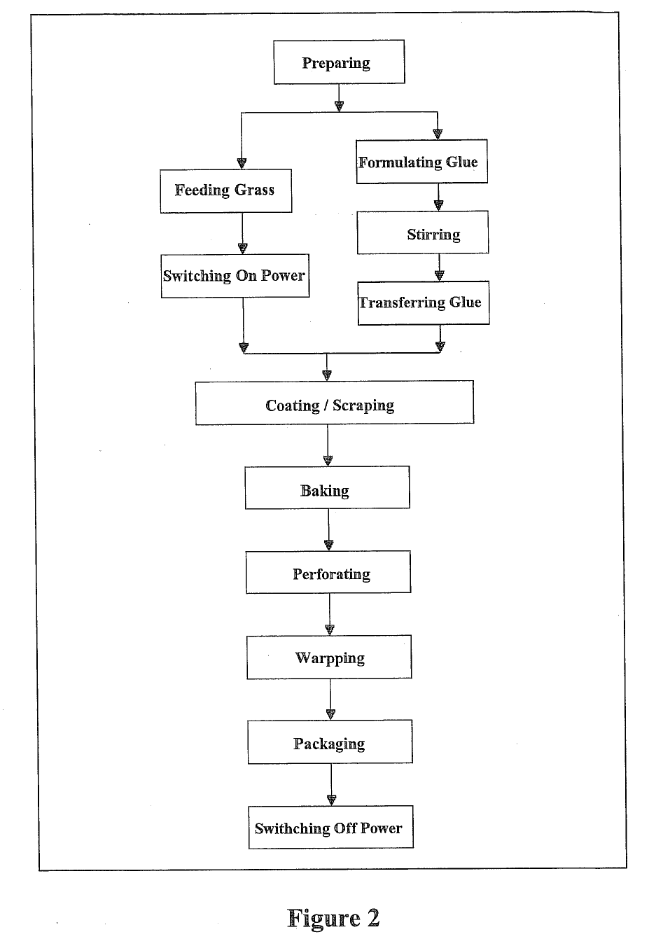

As shown in FIG. 2, detailed process steps are described as follows.
1) The turf to be coated is drawn to the position for feeding grass, with the joints stitched neatly and solidly, and then fed uniformly into the U shape grass box in alignment with the anchor line.
2) The ethylene-vinyl acetate copolymer emulsion, the filler and the color paste are prepared, and the emulsion is introduced from the emulsion tank to the mixing kettle first and stirred for about 5 minutes by the mixer, the filler is added then and stirred for about 30 minutes to form a glue paste, the color paste is added then and stirred again for about 5 minutes after the glue paste is mixed uniformly. The resultant glue paste is sampled for viscosity test, the eligible paste (with a viscosity between 40,000 mPa·s·60,000 mPa·s) is supplied into the paste tank ready for using as the rear glue, and continuous stirring is maintained for prevention from coagulation.
3) After switching on the general power and adjusting the paste roller and the angle of the stentering track, the machine is switched on to increase the temperature and ready for coating when the temperature of the oven reaches 110˜150° C. and the hot air reaches 110˜150° C.
4) The turf is passed through the paste tank and the feeding speed thereof is adjusted at 1.5˜3.2 m/s while opening the valve of the paste reservoir and leaving the glue paste into the paste tank, so as to make the coating uniformly without paste leakage. During scraping of the glue paste, the bottom of the grass fiber should be covered with glue paste, and the amount of the glue paste should be assured to obtain a uniform and solid coating without paste leakage or insufficiency, and the glue paste should be supplemented in time when the glue paste is not enough. The coated turf undergoes thermal treatment by passing it through the hot bellows at a speed of 1.5˜3.2 m/s, with hot air (at a temperature of 110˜150° C.) in the hot bellows blowing the turf from top to bottom.
5) The turf is perforated uniformly by punching with the temperature of the punch needle of 270˜300° C., so as to obtain the uniform aperture size without any skipping.
6) The turf is wrapped and the ends thereof is sure to align with each other.
7) The length of each wrapped turf is sure to consistent with the predetermined length, and each wrapped turf is labeled and packaged with BOPP package film.

### Comparison of Properties

Table 1 shows the result of comparison between the properties of the current artificial turf and the artificial turf of the invention. The following testing result is conducted according to the GB/T 20394-2006.

TABLE 1

| | current | artificial turf |
|---|---|---|
| | artificial turf | of the invention |
| Bonding strength of the | 40~89 N | 40~115 N |
| grass fiber | | |
| Available temperature | −30° C.~70° C. | −30° C.~70° C. |
| range | | |
| Elasticity | eligible | eligible |
| Anti-aging | eligible | eligible |

As can be seen from table 1, the artificial turf of the invention has superior behaviors in bonding strength of the grass than the current artificial turf, and has comparable properties in other properties with the current artificial turf.

### Recycle

The grass fiber, grass bottom and rear glue of the current artificial turf, without being separated in advance, can not be recycled through uniform mixing by conventional apparatus such as double screw extruder when heated to 120˜180° C. Whereas, the grass fiber, grass bottom and rear glue of the artificial turf of the invention, without being separated in advance, can be recycled through uniform mixing by conventional apparatus such as double screw extruder when heated to 120˜180° C. The uniform recycled composite material can be processed into grass bottom of the artificial turf, tables and chairs, buckets, trashes and other products.

The physical and mechanical properties of the composite material obtained by recycle of the artificial turf of the invention are shows as follows.

Recycled artificial turf 1: the rear glue comprised of VAE: 100 wt. %

The grass fiber, grass bottom and rear glue of the artificial turf of the invention having the above composition is crushed and melt blended as a whole, the physical mechanical properties of the resultant material is tested for a sample according to the National Standard and listed as follows.

Tensile strength: 11.6 MPa; tensile modulus: 207 MPa; bending strength: 11.4 MPa; bending modulus: 358 MPa; impact strength: 30 KJ/m².

Recycled artificial turf 2: the rear glue comprised of VAE: 40 wt. %, heavy calcium carbonate: 59 wt. % and antioxidant 1010: 1 wt. %

The grass fiber, grass bottom and rear glue of the artificial turf of the invention having the above composition is crushed and melt blended as a whole, the physical mechanical properties of the resultant material is tested for a sample according to the National Standard and listed as follows.

Tensile strength: 10.3 MPa; tensile modulus: 277 MPa; bending strength: 13.6 MPa; bending modulus: 387 MPa; impact strength: 10.1 KJ/m².

As shown by the above data, the composite material obtained by recycling the artificial turf of the invention as a whole has considerable superior physical mechanical properties and can satisfy the various usages of the common plastic materials.

The invention is not limited to the above examples, and those skilled in the art can make various modifications and alternations, without departing from the scope of the invention as defined by the accompanying claims.

1. An artificial turf comprised of a grass fiber, a grass bottom and a rear glue, wherein the rear glue is mainly made from ethylene-vinyl acetate copolymer emulsion.

2. The artificial turf of claim 1, wherein the grass fiber is mainly made from one or more selected from polyethylene, polypropylene and polyamide, and the grass bottom is mainly made from one or more selected from polyethylene and polypropylene.

3. The artificial turf of claim 1, wherein the rear glue further comprises one or more additives selected from filler and antioxidant.

4. The artificial turf of claim 1, wherein the content of the vinyl acetate in the ethylene-vinyl acetate copolymer is in the range of 70˜90 mol %.

5. The artificial turf of claim 1, wherein the solid content of the ethylene-vinyl acetate copolymer emulsion is in the range of 40˜60 wt. %.

6. The artificial turf of claim 1, wherein the rear glue comprises: 35˜100 wt. % of the ethylene-vinyl acetate copolymer emulsion, 0˜50 wt. % of the filler, 0˜25 wt. % of water and 0˜4 wt. % of the antioxidant.

7. The artificial turf of claim 6, wherein the filler is one or more selected from carbon black, silica, heavy calcium carbonate, light calcium carbonate, talc, montmorillonite, halloysite, magnesium hydroxide and aluminum hydroxide.

8. The artificial turf of claim 6, wherein the antioxidant is one or more selected from antioxidant 1010, antioxidant 245, antioxidant 246, antioxidant 264, antioxidant 3125, antioxidant DSTP, antioxidant DLTP, antioxidant CA, 2,6-di-tert-butyl-4-ethyl phenol, 2,6-di-tert-butyl-4-methoxy-methyl phenol, antioxidant P-EPQ, ditridecyl thiodipropionate and lauryl-stearyl thiodipropionate.

9. A method of manufacturing the artificial turf according to claim 1, comprising the steps of:
making components of the rear glue into a glue paste by uniformly pre-mixing, the components of the rear glue comprising the ethylene-vinyl acetate copolymer emulsion; and
coating the uniformly pre-mixed glue paste onto the grass bottom fixed with the grass fiber.

10. The method of claim 9, wherein the viscosity of the glue paste is in the range of 40,000˜60,000 mPa·s.

11. The method of claim 10, further comprises: after coating the glue paste, thermal-treating the artificial turf coated with the glue paste at a temperature of 110˜150° C.

12. A recycled material obtained by heating and uniformly mixing the artificial turf according to claim 1 as a whole at a temperature of 120˜180° C.
